(19) United States
(12) Patent Application Publication
(10) Pub. No.: US 2025/0320371 A1
(43) Pub. Date: Oct. 16, 2025

(54) COLORED COATINGS WITH CONDUCTIVE AND STATIC DISSIPATIVE ELECTRICAL PROPERTIES

(71) Applicant: Vibrantz Technologies Inc., Houston, TX (US)

(72) Inventors: Santosh K. Yadav, Geneva, OH (US); Paul A. Rettinger, Ashtabula, OH (US)

(21) Appl. No.: 19/177,344

(22) Filed: Apr. 11, 2025

Related U.S. Application Data
(60) Provisional application No. 63/633,332, filed on Apr. 12, 2024.

(51) Int. Cl. C09D 133/04; C08K 3/04; C08K 3/22; C08K 5/00; C09D 7/61; C09D 7/80

(52) U.S. Cl. CPC C09D 133/04; C08K 3/041; C08K 5/0041; C09D 7/61; C09D 7/80; C08K 2003/2241; C08K 2201/001; C08K 2201/005

(57) ABSTRACT

A conductive coating or composites including a conductive carbon nanotube-based color coatings, such as single-wall carbon nanotube (SWCNT)(s) at a low concentration into a conductive coating offers flexibility in color choices. White, bright greens, blue, pink etc. become viable options, ensuring that formulators are not limited to a black or gray finish for their conductive coatings.

### CROSS-REFERENCE TO RELATED APPLICATIONS

This Application claims benefit of U.S. Provisional Application No. 63/633,332, filed Apr. 12, 2024, which is hereby incorporated by reference.

### FIELD OF THE INVENTION

Conductive carbon nanotube-based formulations offer flexibility in color choices.

### BACKGROUND OF THE INVENTION

In recent years, there has been a lot of interest in the advancement of conductive coating and composites, driven by their versatile properties and wide-ranging applications. These cutting-edge coatings find utility across diverse sectors, including construction, electronics, electrodes, aerospace, and automotive industries. There are a few routes exist for producing conducting coating, which include carbon black, metal particles, conducting polymers etc., yet they frequently yield either dark black color, or materials requiring additional processing to attain optimal performance. Consequently, this can escalate material prices, particularly when coupled with rising raw material costs, rendering overall expenses prohibitive for certain applications. For instance, the utilization of silver serves as an example. The average price of silver has exhibited a consistent upward trend in recent years, with silver nanoparticles proving even more costly. In coatings applications, recently industry prioritizes non-metallic compounds, such as carbon materials, to achieve electrical conductivity. The unique characteristics of these coatings, such as electrical conductivity, corrosion resistance, and durability against scratches, are intricately linked to the choice of nanomaterial employed. This patent explores the methodologies, attributes, and practical applications of conductive carbon nanotube-based color coatings. Including SWCNTs at a low concentration into a conductive coating offers flexibility in color choices. White, bright greens, blue, pink etc. become viable options, ensuring that formulators are not limited to a black or gray finish for their conductive coatings.

Carbon Nanotube (CNT) dry powder is very light, fluffy, and tends to go airborne in the presence of minimal air current or draft. Not only is this a loss of potentially valuable material affecting quality, but it is also an EHS concern: too much combustible airborne powder can pose an explosion hazard, and there is little data to tell us about the risks of human exposure to carbon-based nanoparticles. For this reason, material compounder prefers to work with masterbatches or concentrates of CNT unless they have strong engineering and environmental controls. However, there are dilemmas posed by the second approach as well.

In the preparation of a masterbatch or concentrate, there are two issues with which we are concerned: The first is the dispersion of CNT, which deals with the question of breaking apart and dispersing relatively large (micron-scale) agglomerates into much smaller particles and bundles in the range of hundreds of nanometers average particle size. The second issue is the question of exfoliation or debundling of small particles and agglomerates of strands that are tied together by a variety of forces, especially 7L-7L and van der Waals interactions.

CNTs form bundles held together by 7L-7L and van der Waals interactions are generally insoluble and not readily dispersed into monomers, polymers and solvents. This poses a fundamental processing challenge: In order to obtain a gain in electrical, mechanical, or other properties from the use of CNT, it is necessary to achieve a level of dispersion and debundling. For purposes of this invention, dispersion refers to the process of deagglomerating bundles of CNT and dispersing them uniformly into a medium. By contrast, debundling refers to the process of separating bundles of individual strands into smaller bundles and/or individualized strands. The end result must be a uniform distribution of strands through a monomer, solvent, and/or polymeric medium.

### SUMMARY OF THE INVENTION

A conductive coating or composites including a conductive carbon nanotube-based color coatings, such as single-wall carbon nanotube (SWCNT)(s) at a low concentration into a conductive coating offers flexibility in color choices. White, bright greens, blue, pink etc. become viable options, ensuring that formulators are not limited to a black or gray finish for their conductive coatings.

Other methods, features and/or advantages is, or will become, apparent upon examination of the following Figures and detailed description. It is intended that all such additional methods, features, and advantages be included within this description and be protected by the accompanying claims.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are used, and the accompanying drawings of which:

FIG. 1 represents images of a side-by-side drawdowns of a control White coating with and without CNT and a table demonstrating color, viscosity, and electrical resistivity data of the White Base with and without CNT.

FIG. 2 represents images of a side-by-side drawdowns of a control Light Pink coating with and without CNT and a table demonstrating color, viscosity, and electrical resistivity data of the Light Pink with and without CNT.

FIG. 3 represents images of a side-by-side drawdowns of a control Light Orange coating with and without CNT and a table demonstrating color, viscosity, and electrical resistivity data of the Light Orange with and without CNT.

FIG. 4 represents images of a side-by-side drawdowns of a control Light Orange coating with and without CNT and a table demonstrating color, viscosity, and electrical resistivity data of the Light Orange with and without CNT.

FIG. 5 represents images of a side-by-side drawdowns of a control pastel green coating with and without CNT and a table demonstrating color, viscosity, and electrical resistivity data of the pastel green-shade coating with and without CNT.

FIG. 6 represents images of a side-by-side drawdowns of a control pastel green coating with and without CNT and a table demonstrating color, viscosity, and electrical resistivity data of the pastel green with and without CNT.

### DETAILED DESCRIPTION OF THE INVENTION

The following experimental details apply to the preparation and testing of samples prepared according to the invention. Four (4) specific types of measurements were used and are now fully described

Sample viscosity was measured using a TA Instruments DHR-10 Rheometer. Each sample was pre-sheared and conditioned at room temperature, to remove any shear history within the specimen. The sample was tested for rheological characteristics using a 50 mm, 2° cone and plate, from shear rates of 0.01 to 200 s−1 using a controlled shear sweep, at 25° C. Specific measurements were collected at shear rates of 0.02 s−1, 2 s−1, 20 s−1, 100 s−1, and 200 s−1. The value of the viscosities was noted at each of the shear rates mentioned above.

To measure the resistivity/conductivity of each sample, a drawdown was prepared. A Leneta drawdown card was placed on a vacuum plate, and a drawdown bar having thickness of 0.254 mm (0.010 inches, respectively) were used. The drawdowns allowed to flash for 5 minutes, and then baked at 140° F./60° C. for 30 minutes. Linear resistivity (Ohms per inch) was measured using a Ransburg Model 76634-00 using the 1″ contact electrodes at the top of the instrument.

Planar (Ohms per square) resistivity was measured on the same drawdowns using an ACL Staticide model ACL 390 resistivity meter.

Color measurements as reported were taken using an X-Rite Color I-7 spectrometer, using 100 observer, D65 light source, and specular excluded measurements.

### CNT Dispersion and Coatings Preparation

Two critical factors are considered for debundling CNTs and dispersion: applied shear stress and dispersion chemistry. Shear stress is required for debundling, whereas a good and effective additive environment stabilized CNTs and prevents reagglomerating due to high Van der Waals forces. With these considerations in mind, CNTs is mixed into a solution of additives and monomers, polymers, solvents using a flat blade. This suspension can be then processed with a 2-rol mill or 3-roll mill. Following are examples of our making use of CNT dispersions to achieve electrical properties in composite formulations.

For this study, several commercially available, undispersed, dry-powder CNT samples were obtained and evaluated. In general, the dry CNT samples were incorporated into a resin matrix under high shear agitation, and subsequently dispersed via high shear mixing such as 3 roll, 2 roll mixing, in such a manner as to avoid introduction of undesired defects. However, this is not as simple as it sounds; there is a process that must be followed.

CNT and single-wall carbon nanotube (SWCNT) is an extremely light and fluffy material. The moment a container of CNT is opened, small air currents are likely to cause small light agglomerates of CNT to become airborne, and float through the air, causing it to become airborne. We have created a video which demonstrates this behavior, as well as the benefit of the use of a masterbatch dispersion for our customers. However, suffice it to say that the opening of a CNT container, and subsequent introduction of CNT to liquid resin or solvent, prior to and during mixing, must be performed under carefully controlled conditions.

In this work, a masterbatch dispersion of 10% CNT (w/w) was prepared as described in U.S. Pat. No. 11,981,567 B2 and U.S. Pat. No. 12,234,342 B2, which are hereby incorporated by reference. Using the described masterbatch, an acrylic white base formula was prepared as described below:

TABLE 1
Solvent Acrylic White Base Formulations:

| | Wt % | |
|---|---|---|
| | Control | CNT |
| | White | White |
| Material Description | Base | Base |
| Polymethylmethacrylate (solid) | 29.31% | 29.29% |
| Aromatic solvent | 11.47% | 11.46% |
| Ketone solvent, e.g., MEK, MIBK, | 11.47% | 11.46% |
| MAK | | |
| Acetate solvent, e.g., PM Acetate | 8.60% | 8.60% |
| Linear aliphatic ester plasticizer | 1.59% | 1.59% |
| High boiling ketone/ester solvent | 1.27% | 1.27% |
| Polymeric hyperdispersant | 1.05% | 1.05% |
| Rheological modifier (solid) | 0.17% | 0.17% |
| Class III/IV/VII titanium dioxide | 35.05% | 35.03% |
| Vehicle Subtotal: | 100.00% | 99.94% |
| CNT Masterbatch | 0.00% | 0.06% |
| Total: | 100.00% | 100.00% |

As can be seen in the above table, two (2) white base formulations were prepared. In one of them, CNT was added to the batch under high shear agitation and mixed thoroughly to 7 NS Hegman using a Cowles high speed disperser. The blade was approximately one half the diameter of the mix vessel, and the tip speed of the disperser varied between 1000 and 2000 feet per minute. Temperature of the process was controlled via water cooling to under 120° F. In the other formulation, which served as a control, addition, no CNT was added, but the formulation was processed in an otherwise identical manner.

To prepare the base for application as a coating, solvent and plasticizer was added as a letdown as described in Table 2.

TABLE 2
Solvent Acrylic White Coatings:

| | Wt % | |
|---|---|---|
| | Control | CNT |
| | White | White |
| Material Description | Coating | Coating |
| Control White Base | 86.22% | |
| CNT White Base | | 86.22% |
| Ketone solvent, e.g., MEK, MIBK, | 5.49% | 5.49% |
| MAK | | |
| Acetate solvent, e.g., PM Acetate | 7.99% | 7.99% |
| Linear aliphatic ester plasticizer | 0.10% | 0.10% |
| High boiling ketone/ester solvent | 0.20% | 0.20% |
| Total: | 100.00% | 100.00% |

In coatings, pigment to binder ratio is somewhat critical. According to one aspect of the present invention, the ratio of pigment binder is about 1.1:1, or 110% based upon binder. In some aspects of the invention, the ratio of pigment binder is represented as between 0.1% and 120% pigment based upon solid binder resin. In some aspects, a pigments such as titanium dioxide or iron oxide is present and the pigment may be loaded in concentrations that are very high. In some aspects, the pigment such as an organic pigments (including carbon black) may be loaded as low as 0.1% based on binder. In some aspects of the invention, a combination of pigments is provided for use in the coatings of the instant invention.

Initially for testing, the above formulations were applied by steel applicator as 20-mil drawdowns onto cold rolled steel and Leneta charts. The coating was allowed to flash for ten minutes at room temperature, and then force dried for 30 minutes at 140° F.

Next, to 100 g aliquots of the above white coatings, 0.2 g of dispersions of differing pigments were added, and the resulting coating was applied in the same manner. Colorants used were:
A. Brilliant red: C.I. Pigment Red 254, Vibrantz Chroma-Chem UCD-6580;
B. Orange: C.I. Pigment Orange 36, Vibrantz Chroma-Chem 844-0982;
C. Red-shade violet: C.I. Pigment Violet 19, Vibrantz Chroma-Chem 844-0451;
D. Green: C.I. Pigment Green 7, Vibrantz Chroma-Chem 844-5558;
E. Blue: C.I. Pigment Blue 15:1, Vibrantz Chroma-Chem 844-7262.

Therefore, according to one aspect of the invention, a coating that comprises both CNT and pigment to produce a base formulation, a coating, a resin, a solvent-borne coating, a film, a composite, a molded article that results in a product that is white, or a hue of red, orange, yellow, green, indigo, blue, or violet. In one aspect of the invention, the CNT may be a SWCNT or a combination of multi-walled and single-walled CNT and may be in the form of a CNT masterbatch.

The formulations of the invention can provide a base formulation that contains carbon nanotube and a pigment. Pigment may be added to the base coat to provide a hue of red, orange, yellow, green, indigo, blue, or violet. The term “hue” is meant to indicate that formulations, even though they contain carbon nanotube, provide a base coat a color that an ordinary observer would readily identify the color of the base formulation as “red”, “orange”, “yellow”, “green”, “blue”, or “purple”.

According to one aspect of the invention, a coating includes a base formulations. In some aspects, the base formulation is a white base. In some aspects, the base formulation may be termed a “vehicle”. To the base or white base formulation may form the basis of a coating. The base formulation is generally in the form of a composition comprising: a solvent, a polyacrylate, a plasticizer, a rheological modifier, a pigment, and a CNT masterbatch.

According to one aspect of the invention, the solvents include aromatic solvents, ketone solvents, acetate solvents, ester solvents.

According to one aspect of the invention, the white base formulation comprises: polyacrylate in an amount of about 25 wt % to about 32 wt %, solvents in an amount of about 30 wt % to about 35 wt %, a plasticizer in an amount of about 1 wt % to about 3 wt %, additives in an amount of about 1 wt % to about 3 wt %, a pigment in an amount of about 32 wt % to about 42.5 wt %, and a CNT masterbatch in an amount of about 0.5 wt % to about 2 wt %. In one aspect of the invention, additives may of the white base formulation include hyperdispersant, rheological modifiers and the like. In one aspect of the invention, the white base formulation may comprise a class III/IV/VII titanium dioxide. In one aspect of the invention, an additional pigment is added to the white base formulation to produce a red base formulation, an orange base formulation, a yellow base formulation, a green base formulation, a blue base formulation, or a purple base formulation.

In some aspects, the base formulation is combined additional solvents and plasticizers to form a composition suitable for forming a coating, resin or film. In some aspects, the coating, resin or film comprises about 86 wt %, about 13.5 wt %, and about 0.5 wt %. In some aspects, the coating, resin or film comprises base formulation in an amount of about 84.5 wt % to about 88 wt %, solvent in an amount of about 12 wt % to about 15 wt %, and a plasticizer in an amount of about 0.01 wt % to about 0.5 wt %.

### Test Methods:

Color measurements were taken using an X-Rite Color 17 using 100 observer, specular included, sphere geometry. Viscometry measurements were taken using a TA Instruments HR-10 rheometer using 50 mm 2° cone and plate geometry. Electrical conductivity measurements were taken by connecting electrodes to thin (6-mil) films at the surface or by sandwiching between copper plates. This allowed for measurements of linear (Q/cm), planar (Q/square), and volumetric (Q/cm³) resistivity, using Sperry Model DM-350A, Staticide ACL, and Ransburg Model 76634-00 Ohm meters, respectively. By this method, we were able to reproducibly measure resistivity of thin-film coatings in ranges of 10⁴ through 10¹³ Ω/cm.

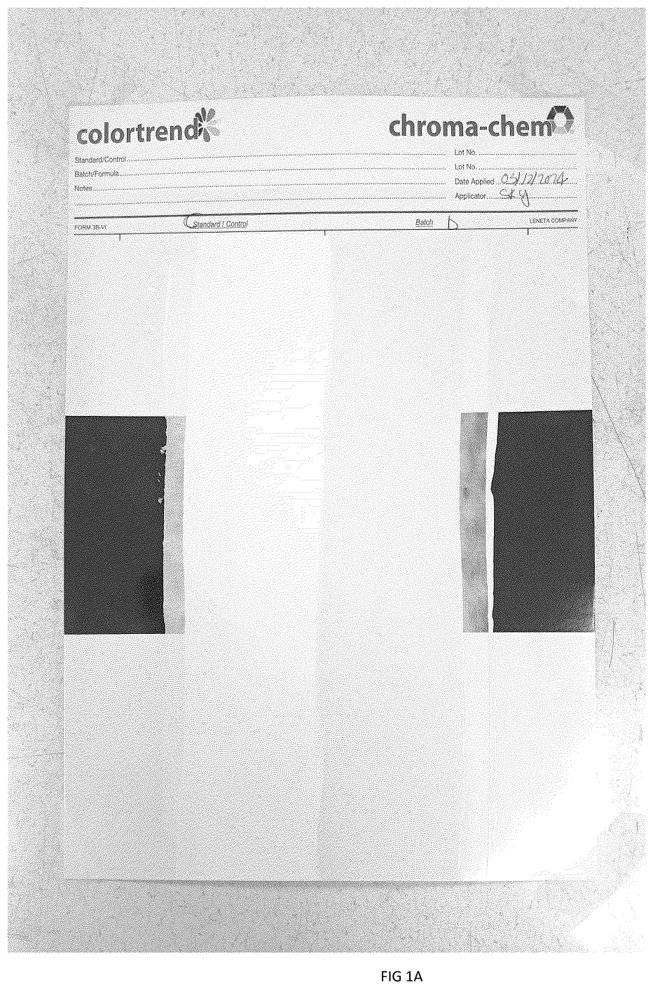

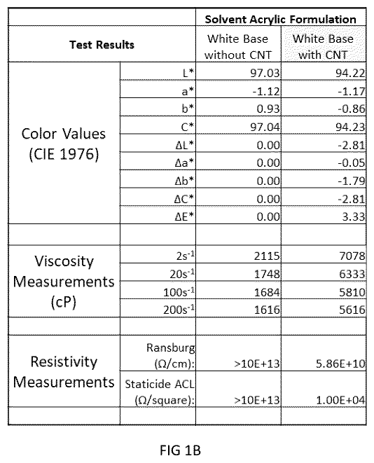

FIGS. 1-6 are tables and images illustrating results. FIG. 1: Side-by-side drawdowns of a control White coating without CNT, and the same White coating but with CNT incorporated, with color, viscosity, and electrical resistivity data.

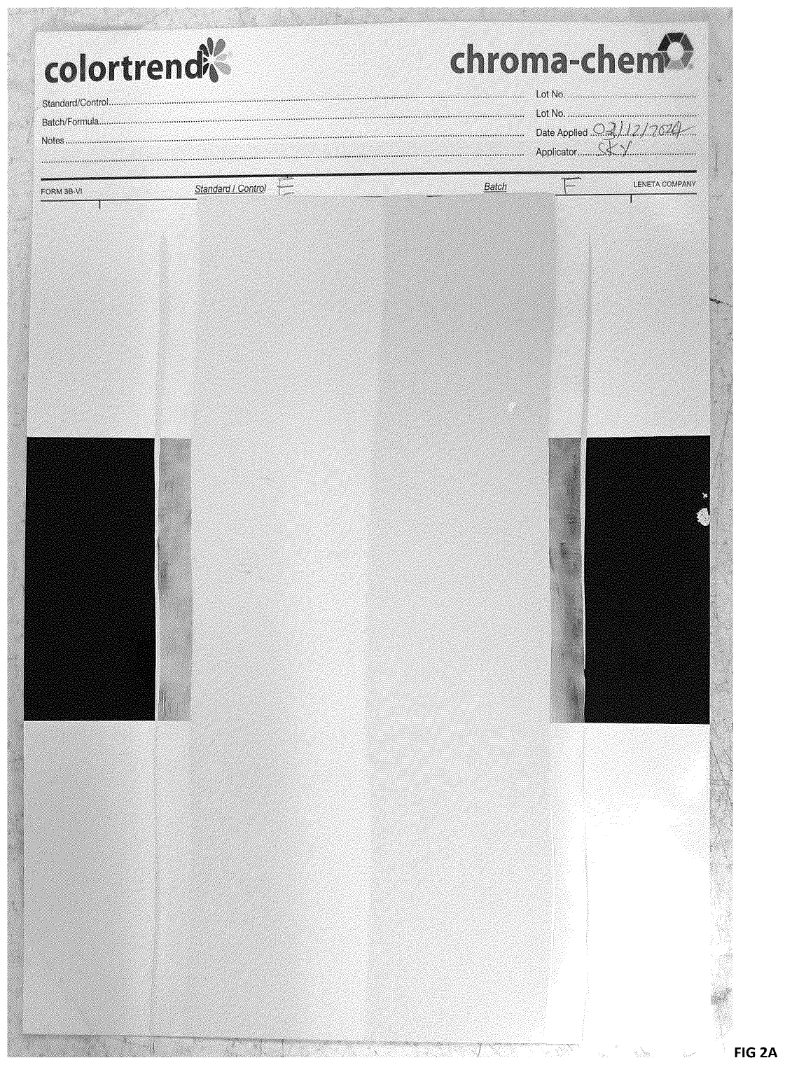

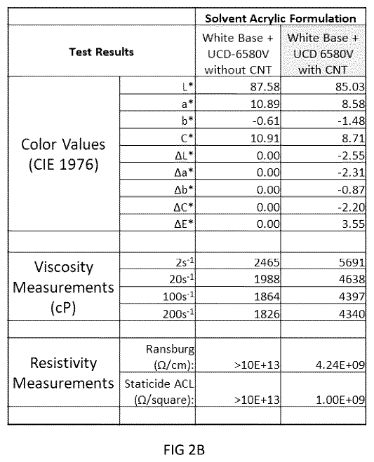

FIG. 2: Side-by-side drawdowns of a control Light Pink coating, with and without CNT, with color, viscosity, and electrical resistivity data. In this example, a dispersion of C.I. Pigment Red 254 (Vibrantz Chroma-Chem UCD-6580V) was added (0.2% w/w) to our white coating to produce a light pink color.

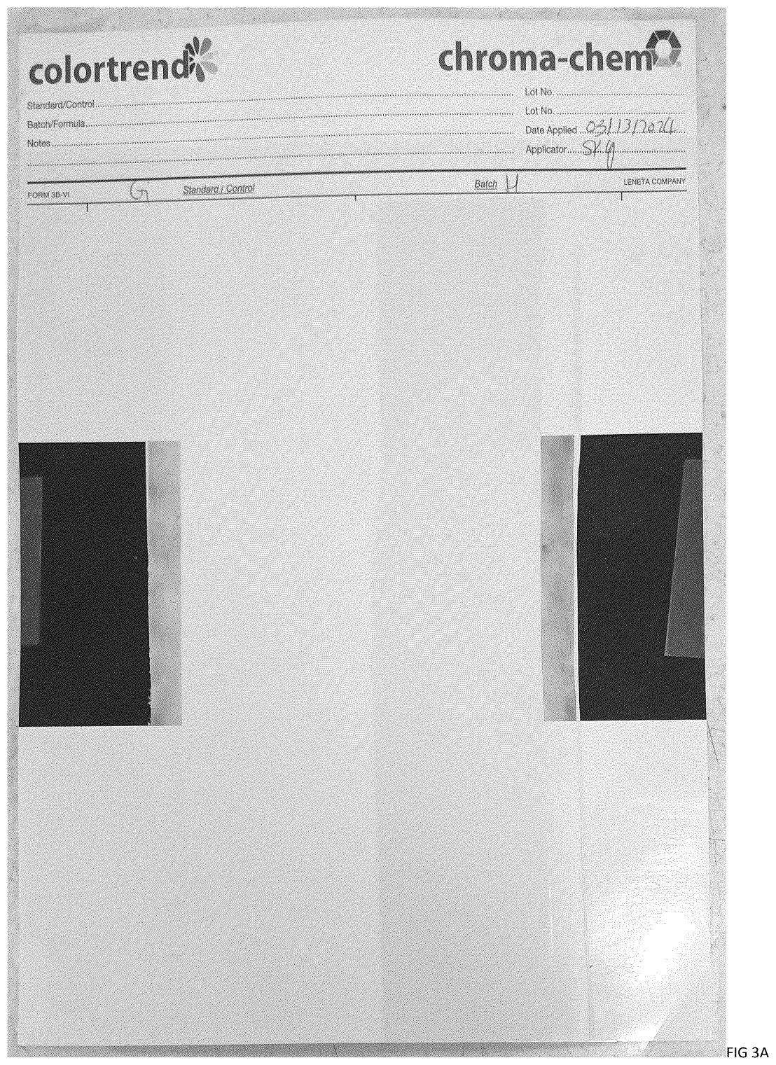

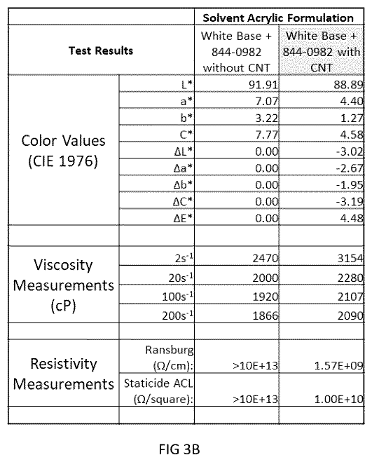

FIG. 3: Side-by-side drawdowns of a control Light Orange coating with, and without CNT, with color, viscosity, and electrical resistivity data. In this example, a dispersion of C.I. Pigment Orange 36 (844-0982) was added (0.2% w/w) to the white coating to produce a pastel orange color.

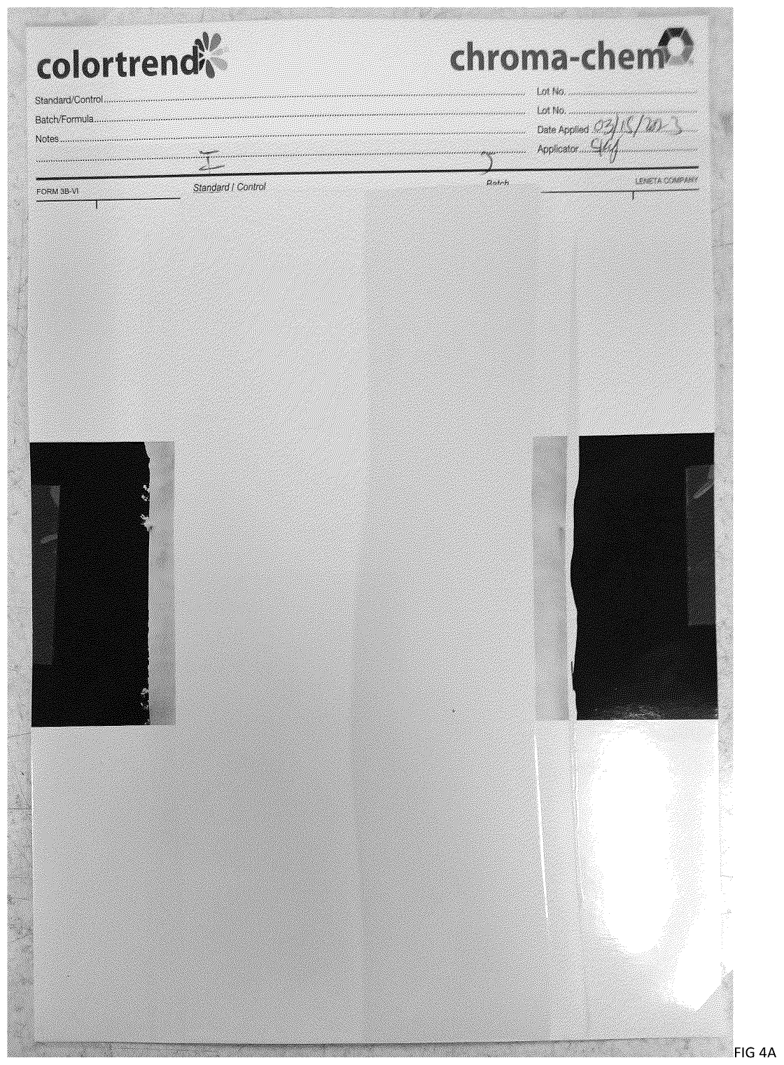

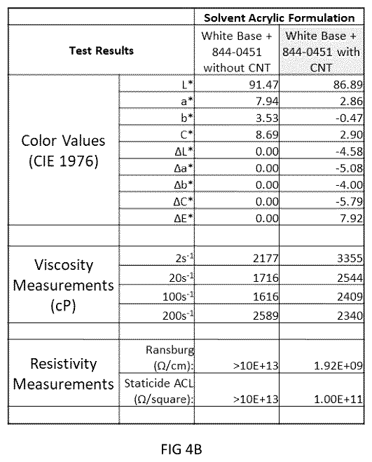

FIG. 4: Side-by-side drawdowns of a pastel red-shade coating, with and without CNT, with color, viscosity, and electrical resistivity data. In this example, a dispersion of red-shade C.I. Pigment Violet 19 (844-0451) was added (0.2% w/w) to the white coating to produce a pastel red-shade color.

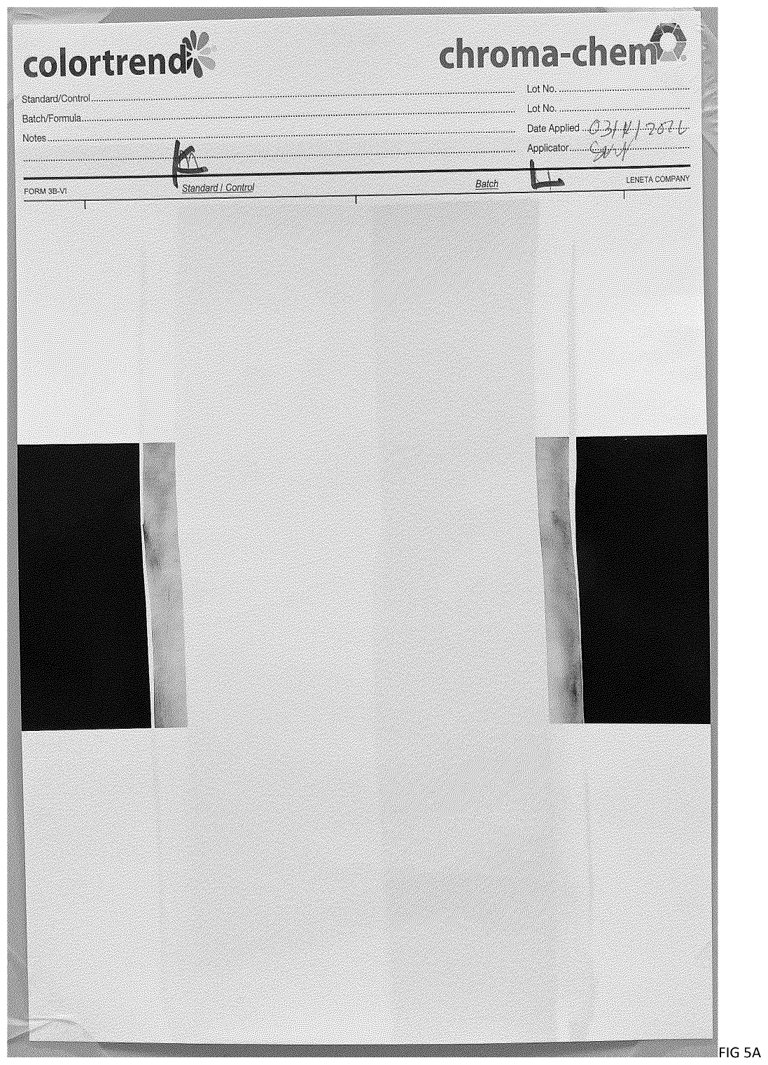

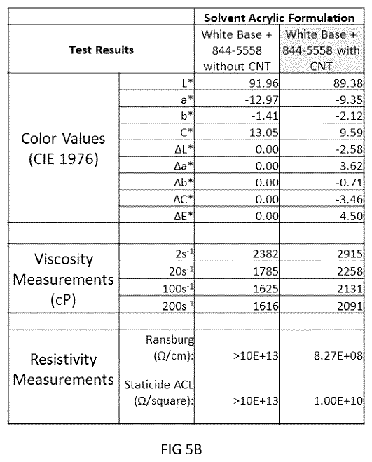

FIG. 5: Side-by-side drawdowns of a pastel green coating, with and without CNT, with color, viscosity, and electrical resistivity data. In this example, a dispersion of red-shade C.I. Pigment Green 7 (844-5558) was added (0.2% w/w) to the white coating to produce a pastel red-shade color.

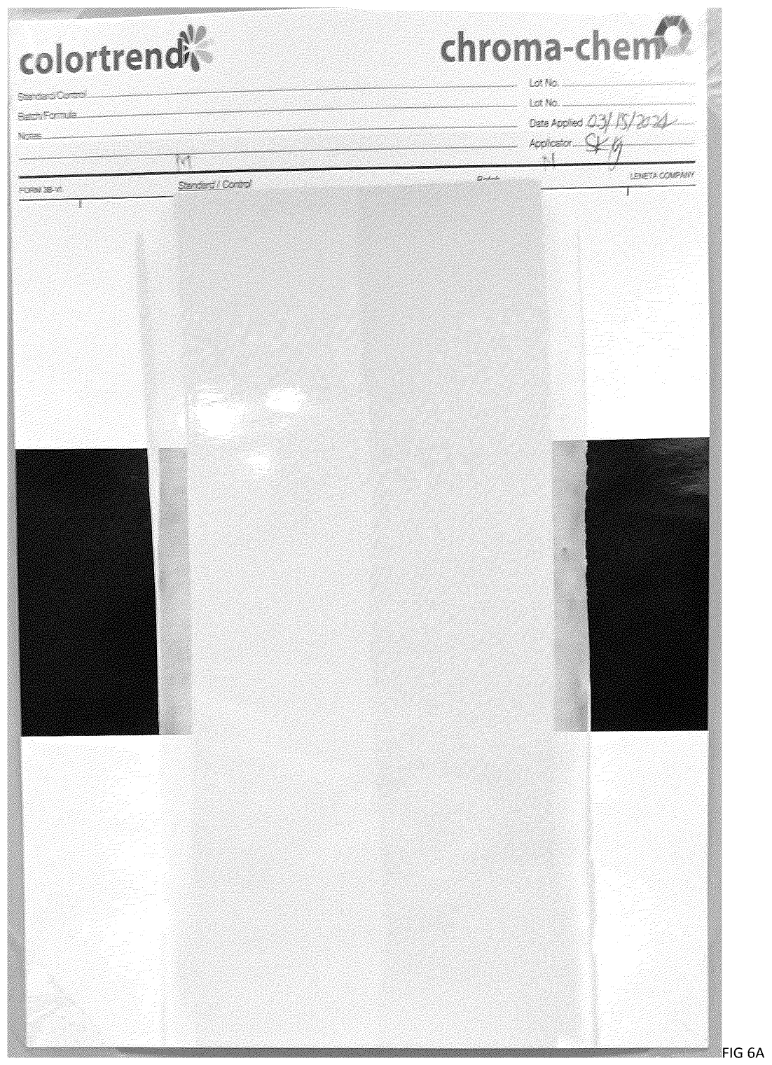

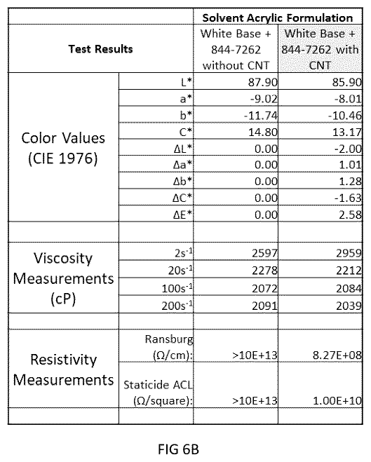

FIG. 6: Side-by-side drawdowns of a pastel green coating, with and without CNT, with color, viscosity, and electrical resistivity data. In this example, a dispersion of red-shade C.I. Pigment 15 (844-7262) was added (0.2% w/w) to the white coating to produce a pastel red-shade color.

To the extent that the term “includes” or “including” is used in the specification or the claims, it is intended to be inclusive in a manner similar to the term “comprising” as that term is interpreted when employed as a transitional word in a claim. “Consisting of” is a term applied to a composition containing only recited elements, for example A and B. “Consisting essentially of” is a term applied to a composition containing recited elements, A and B but may additionally contain compounds such as water or solvent. Furthermore, to the extent that the term “or” is employed (e.g., A or B) it is intended to mean “A or B or both.” When “only A or B but not both” is intended, then the term “only A or B but not both” will be employed. Thus, use of the term “or” herein is the inclusive, and not the exclusive use. As used in the specification and the claims, the singular forms “a,” “an,” and “the” include the plural. Finally, where the term “about” is used in conjunction with a number, it is intended to include ±1% of the number. For example, “about 10” may mean from 9 to 11. The term wt % is meant to describe a comparison of the weight of one compound to the weight of the whole composition expressed as a percent. It can also be described as wt. %, or (w/w) %.

As stated above, while the present application has been illustrated by the description of embodiments, and while the embodiments have been described in considerable detail, it is not the intention to restrict or in any way limit the scope of the appended claims to such detail. Additional advantages and modifications will readily appear to those skilled in the art, having the benefit of this application. Therefore, the application, in its broader aspects, is not limited to the specific details and illustrative examples shown. Departures may be made from such details and examples without departing from the spirit or scope of the general inventive concept.

We claim:

1. A solvent-borne coating comprising solid binder resin, between about 0.1 and 15% (w/w) of CNT, and between about 0.1% and 120% (w/w) pigment based on solid binder resin.

2. The solvent-borne coating of claim 1, wherein the pigment is a red, orange, yellow, green, blue, violet, purple or any hue thereof.

3. A solvent-borne coating characterized by an L*>80 (CIE 1976), resistivity 10⁴-10¹¹ Ω/cm or Ω/square and having a viscosity <10 Pa·S at 2-200^{s-1}.

4. The coating of claim 1, wherein the coating comprises between about 0.1 and 15% (w/w) of CNT.

5. The coating of claim 4, wherein the CNT is provided to a coating mixture in the form of a CNT masterbatch.

6. A coatings-grade resin comprised of a resin and the solvent-borne coating of claim 1.

7. The coatings-grade resin of claim 1, wherein the resin is characterized by a thermoplastic functionality, a thermoset functionality, or a combination thereof which has a viscosity <10 Pa·S at 2-200^{s-1}.

8. A method of preparing a solvent-borne coating prepared by a method comprising: combining a solvent-borne coating with a high-speed disperser with tip speed 700-2100 feet per minute.

9. A method of claim 8 wherein the solvent-borne coating further comprises 30-70% titanium dioxide with a mean particles size of 150-400 nm.

10. The method of claim 7, wherein the pigment is red, orange, yellow, green, blue, indigo, violet, or purple.
